(19) United States
(12) Patent Application Publication
(10) Pub. No.: US 2007/0184697 A1
(43) Pub. Date: Aug. 9, 2007

(54) Connector

(76) Inventors: Yukihiko Taguchi, Maebashi-shi (JP); Yoshihiro Ochiai, Tomioka-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/573,315

(22) PCT Filed: Aug. 3, 2005
(86) PCT No.: PCT/JP05/14169

§ 371 Date: Feb. 6, 2007

(30) Foreign Application Priority Data
Aug. 6, 2004 (JP) 2004-231327

(51) Int. Cl. H01R 27/00

(52) U.S. Cl. 439/218

(57) ABSTRACT

A connector is provided to be connected to a solenoid embedded in a hole formed on a housing of a device to be attached. The connector is provided with connector electric terminal members which can be engaged with electric terminal members of the solenoid, and a case which stores the connector electric terminal members, is removably attached to the solenoid and covers an opening edge part of the hole. The structure of the connector requires lower process cost for ensuring waterproof and corrosion resistance of the solenoid, compared with a conventional structure.

### TECHNICAL FIELD OF THE INVENTION

The present invention relates to a connector connected to a solenoid embedded in a hole formed on a housing of a device to be attached.

### BACKGROUND OF THE INVENTION

A connector connected to a solenoid embedded in a hole formed on a housing of a device to be attached is disclosed, for example, in Patent Document 1.

Since this connector of Patent Document 1 is attached to a solenoid housing one end of which is exposed to the atmosphere from an opening edge part of the above-described hole, in order to ensure the waterproof and corrosion resistance of a solenoid, it is considered that it is necessary to carry out a surface treatment for corrosion resistance on the outer surface of the solenoid housing, and it causes increase of cost for manufacturing the solenoid. Patent Document 1: JP-A-11-159449

### DISCLOSURE OF THE INVENTION

### Problems to be Solved by the Invention

Accordingly, an object of the present invention is to provide a connector connected to a solenoid embedded in a hole formed on a housing of a device to be attached, which can reduce the process cost for ensuring waterproof and corrosion resistance of the solenoid, compared with a conventional structure.

### Means for Solving the Problems

To achieve the above objects, a connector according to the present invention is connected to a solenoid embedded in a hole formed on a housing of a device to be attached, and the connector comprises connector electric terminal members capable of being engaged with electric terminal members of the solenoid, and a case which stores the connector electric terminal members, which is removably attached to the solenoid and which covers an opening edge part of the hole.

In this connector according to the present invention, because the case of the connector covers the opening edge part of the hole in which the solenoid is embedded, the solenoid is not exposed directly to the outside environment, and there is few chance of contact with moisture. Therefore, even if the grade of the treatment for ensuring the waterproof and corrosion resistance is reduced as compared with a conventional grade, the waterproof and corrosion resistance of the solenoid can be ensured. Therefore, in the connector according to the present invention, the process cost for ensuring the waterproof and corrosion resistance of the solenoid can be reduced, compared with a conventional structure.

In the connector according to the present invention, it is preferred that a seal member is provided for sealing a gap between the case and the opening edge part of the hole. By the structure where the seal member is disposed for sealing a gap between the case of the connector and the opening edge part of the hole in which the solenoid is embedded, the solenoid is completely isolated from outside environment, and contact chance with moisture is wiped out. As a result, the process cost for ensuring the waterproof and corrosion resistance of the solenoid can be further reduced.

Further, in the connector according to the present invention, it is preferred that the case is molded with a resin. By molding the case of the connector with a resin, it is facilitated to make the shape of the case complicated, the electric insulation property of the connector may be improved, and the connector may be made light.

Further, in the connector according to the present invention, it is preferred that a rotation preventing mechanism is formed at an engaging portion between the case and the solenoid. By preventing rotation of the connector relative to the solenoid, it is prevented that an excessive force is applied to electric terminal members of both the connector and the solenoid and the electric terminal members are damaged.

Further, in the connector according to the present invention, it is preferred that a removal preventing mechanism is formed at an engaging portion between the case and the solenoid. By this, removal of the connector from the solenoid may be prevented.

Further, in the connector according to the present invention, it is preferred that a rotation preventing mechanism for preventing rotation of the case relative to the housing of the device to be attached is formed at an engaging portion between the case and the housing of the device to be attached. By this, it is prevented that the connector rotates by receiving an external force and electric terminal members are damaged.

Further, in the connector according to the present invention, it is preferred that a removal preventing member engaged with the hole of the housing of the device to be attached is provided for engaging the case and preventing removal of the case from the hole. By this, removal of the connector from the housing of the device to be attached may be prevented, and ultimately, removal of the solenoid from the housing of the device to be attached may be prevented.

Further, in the connector according to the present invention, it is preferred that a diode is disposed between the connector electric terminal members. By disposing a diode in the connector, the structure of the solenoid may be simplified.

Such a connector according to the present invention is suitable in a case where the device to be attached is a variable displacement compressor, and in particular, suitable in a case where the variable displacement compressor is a compressor used in an air conditioning system for a vehicle.

### Effect According to the Invention

In the connector according to the present invention, because the case of the connector covers the opening edge part of the hole in which the solenoid is embedded, the solenoid is not exposed directly to the outside environment, and there is few chance of contact with moisture. Therefore, even if the grade of the treatment for ensuring the waterproof and corrosion resistance is reduced as compared with a conventional grade, the waterproof and corrosion resistance of the solenoid can be ensured. Therefore, in the connector according to the present invention, the process cost for ensuring the waterproof and corrosion resistance of the solenoid can be reduced, compared with a conventional structure.

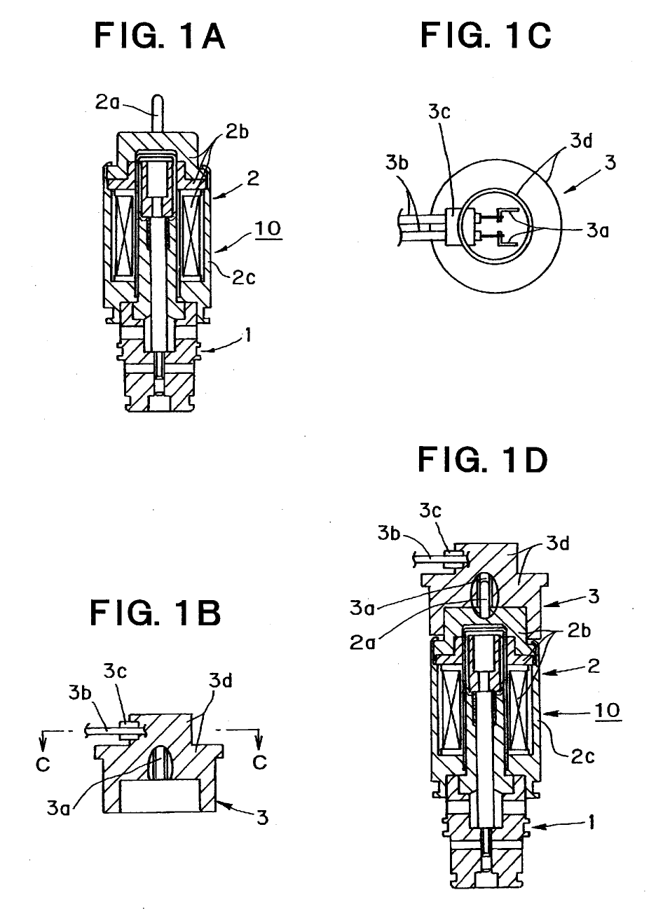

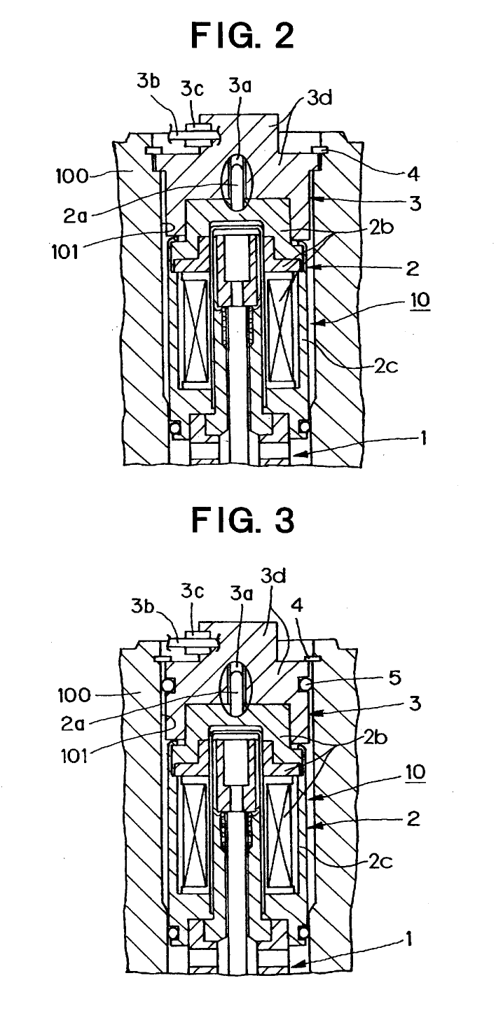

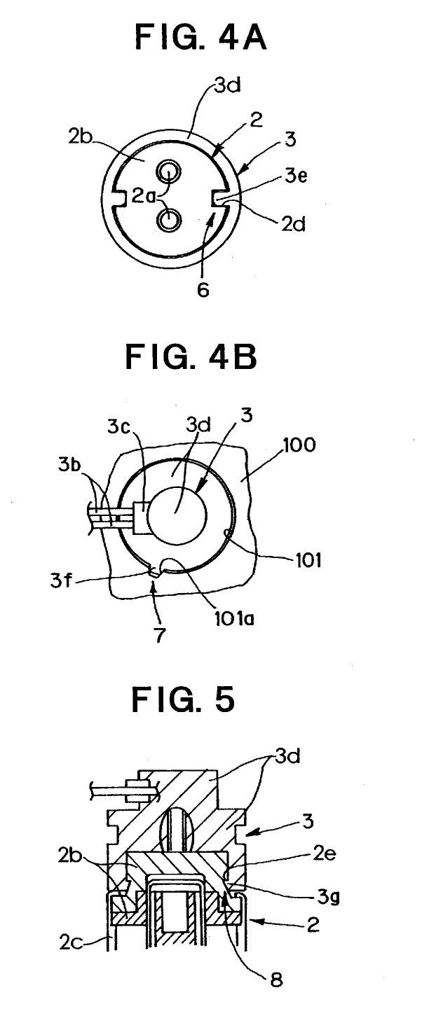

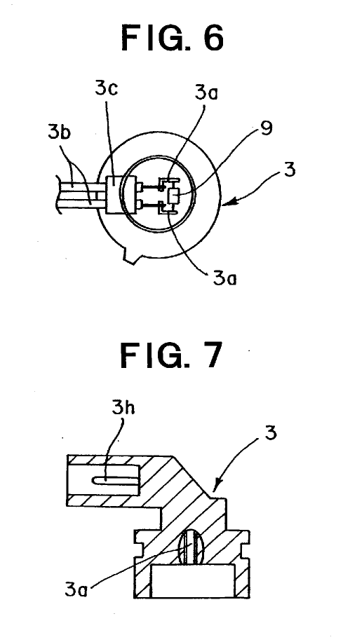

### BRIEF EXPLANATION OF THE INVENTION

[FIG. 1] FIG. 1 shows a structure of a solenoid valve provided with a connector according to an embodiment of the present invention, FIG. 1A is a vertical sectional view of a valve part and a solenoid, FIG. 1B is a vertical sectional view of the connector, FIG. 1C is a cross-sectional view along line C-C of FIG. 1B, and FIG. 1D is a vertical sectional view at a state where the valve part, the solenoid and the connector are integrally assembled. In FIGS. 1B and 1D, a part of members are perspectively depicted and electric terminal members are shown at an exposed condition.

[FIG. 2] FIG. 2 is a partial, vertical sectional view of a solenoid valve provided with a connector according to an embodiment of the present invention, at a state being attached to a housing of a variable displacement compressor. A part of members are perspectively depicted and electric terminal members are shown at an exposed condition.

[FIG. 3] FIG. 3 is a partial, vertical sectional view of a solenoid valve provided with a connector according to another embodiment of the present invention, at a state being attached to a housing of a variable displacement compressor. A part of members are perspectively depicted and electric terminal members are shown at an exposed condition.

[FIG. 4] FIG. 4 shows a structure of a solenoid valve provided with a connector according to a further embodiment of the present invention, FIG. 4A is a cross-sectional view of an engaging portion between the connector and a solenoid, and FIG. 4B is a plan view of an engaging portion between the connector and a compressor housing.

[FIG. 5] FIG. 5 is a vertical sectional view of an engaging portion between a connector and a solenoid in a solenoid valve provided with the connector according to a further embodiment of the present invention. A part of members are perspectively depicted and electric terminal members are shown at an exposed condition.

[FIG. 6] FIG. 6 is a cross-sectional view of a portion corresponding to the portion depicted in FIG. 1C in a connector according to a further embodiment of the present invention.

[FIG. 7] FIG. 7 is a vertical sectional view of a connector according to a further embodiment of the present invention.

### EXPLANATION OF SYMBOLS

1: valve part
2: solenoid
2a: electric terminal member of solenoid
2b: solenoid body
2c: solenoid housing
2d: groove for engagement
2e: stepped portion for engagement
3: connector
3a: connector electric terminal member
3b: lead wire
3c: insulation rubber
3d: case
3e, 3f: projection for engagement
3g: claw for engagement
3h: terminal member
4: snap ring
5: O-ring
6, 7: rotation preventing mechanism
8: removal preventing mechanism
9: diode
10: solenoid valve
100: housing of variable displacement compressor
101: hole
101a: groove for engagement

### THE BEST MODE FOR CARRYING OUT THE INVENTION

Hereinafter, desirable embodiments of connectors according to the present invention will be explained as to a case of a connector capable of being applied to a displacement control solenoid valve of a variable displacement compressor, particularly, of a variable displacement compressor suitable for use in an air conditioning system for a vehicle.

FIG. 1 shows a solenoid valve provided with a connector according to an embodiment of the present invention. In FIG. 1, a displacement control solenoid valve 10 of a variable displacement compressor has a valve part 1, a solenoid 2 for driving a valve, and a connector 3 which is removably attached to solenoid 2. Solenoid 2 has a solenoid body 2b including a pair of electric terminal members 2a, and a solenoid housing 2c.

Connector 3 is constructed from a pair of connector electric terminal members 3a which can be attached to and detached from the pair of electric terminal members 2a of solenoid 2, a pair of lead wires 3b coupled to connector electric terminal members 3a, an insulation rubber 3c, and a case 3d made of a resin which stores connector electric terminal members 3a.

Connector electric terminal members 3a are insert molded integrally with case 3d. Insulation rubber 3c attached to lead wires 3b and closing the peripheries of lead wires 3b is engaged to an end portion of case 3d, lead wires 3b and connector electric terminal members 3a are coupled, a resin is injected into case 3d surrounding the coupling portion and a lid is provided thereon, and connector 3 is thus formed.

As depicted in FIG. 2, solenoid valve 10 is attached to a housing 100 of the variable displacement compressor at a state where valve part 1 and solenoid 2 are embedded in a hole 101 formed on housing 100 of the variable displacement compressor, case 3d of connector 3 is removable attached to solenoid body 2b, connector electric terminal members 3a are engaged with electric terminal members 2a, case 3d of connector 3 covers the opening edge part of hole 101, and a snap ring 4 engaged with a circumferential groove formed on the opening edge part of hole 101 is engaged with the end surface of case 3d of connector 3.

In connector 3 according to this embodiment, because case 3d covers the opening edge part of hole 101 in which solenoid 2 is embedded, solenoid 2 is not exposed directly to outside environment, and there is few chance of contact with moisture. Therefore, even if the grade of the treatment for ensuring the waterproof and corrosion resistance is reduced as compared with a conventional grade, the waterproof and corrosion resistance of solenoid 2 can be ensured. Therefore, in connector 3, the process cost for ensuring the waterproof and corrosion resistance of solenoid 2 can be reduced, compared with a conventional structure.

Moreover, by molding case 3d of connector 3 with a resin, it is facilitated to make the shape of case 3d complicated, the electric insulation property of connector 3 may be improved, and connector 3 may be made light.

Further, by providing snap ring 4, removal of connector 3 from housing 100 may be prevented, and removal of solenoid 2, ultimately, solenoid valve 10, from housing 100 may be prevented.

FIG. 3 depicts a solenoid valve according to another embodiment. In this embodiment, as depicted in FIG. 3, a gap between the opening edge part of hole 101 and case 3d is sealed by an O-ring 5 provided as a seal member stored in a circumferential groove which is formed on the periphery of case 3d. In this structure, solenoid 2 is completely isolated from outside environment, contact chance with moisture is wiped out, and therefore, the process cost for ensuring the waterproof and corrosion resistance of solenoid 2 can be further reduced.

FIG. 4 depicts a solenoid valve according to a further embodiment. In this embodiment, as depicted in FIG. 4A, a rotation preventing mechanism 6 comprising a groove for engagement 2d formed on solenoid body 2b and a projection for engagement 3e formed on case 3d engaging with groove for engagement 2d is formed at an engaging portion between case 3d of connector 3 and solenoid body 2b. By preventing rotation of connector 3 relative to solenoid 2, it is prevented that an excessive force is applied to electric terminal members 2a and 3a of both connector 3 and solenoid 2 and electric terminal members 2a and 3a are damaged.

Further, as depicted in FIG. 4B, a rotation preventing mechanism 7 comprising a groove for engagement 101a formed on the circumferential wall of hole 101 and a projection for engagement 3f formed on the periphery of case 3d engaging with groove for engagement 101a may be formed at an engaging portion between case 3d of connector 3 and hole 101. It is prevented that connector 3 rotates by receiving an external force and lead wires 3b are damaged.

FIG. 5 depicts a solenoid valve according to a further embodiment. In this embodiment, as depicted in FIG. 5, a removal preventing mechanism 8 comprising a claw for engagement 3g formed on case 3d and a stepped portion for engagement 2e formed on solenoid body 2b with which claw for engagement 3g is engaged is formed at an engaging portion between case 3d of connector 3 and solenoid body 2b. By forming this removal preventing mechanism 8, removal of connector 3 from solenoid 2 may be prevented.

FIG. 6 depicts a solenoid valve according to a still further embodiment. In this embodiment, as depicted in FIG. 6, a diode 9 for absorbing surging is disposed between the pair of connector electric terminal members 3a of connector 3. By providing diode 9 not to solenoid 2 but to connector 3, the structure of solenoid 2 may be simplified, and the productivity of solenoid valve 10 may be improved.

FIG. 7 depicts a connector according to a further embodiment. In this embodiment, as depicted in FIG. 7, instead of lead wires 3b, terminal members 3h are disposed in connector 3.

Further, although not depicted, an appropriate engaging portion for removing connector 3 attached to housing 100 by using a jig may be formed on case 3d of connector 3.

### INDUSTRIAL APPLICATIONS OF THE INVENTION

The connector according to the present invention can be suitably used not only for a solenoid valve for displacement control of a variable displacement compressor but also for various solenoids attached to housings of devices.

1. A connector connected to a solenoid embedded in a hole formed on a housing of a device to be attached, said connector comprising:
connector electric terminal members capable of being engaged with electric terminal members of said solenoid; and
a case which stores said connector electric terminal members, which is removably attached to said solenoid and which covers an opening edge part of said hole.

2. The connector according to claim 1, wherein a seal member is provided for sealing a gap between said case and said opening edge part of said hole.

3. The connector according to claim 1, wherein said case is molded with a resin.

4. The connector according to claim 1, wherein a rotation preventing mechanism is formed at an engaging portion between said case and said solenoid.

5. The connector according to claim 1, wherein a removal preventing mechanism is formed at an engaging portion between said case and said solenoid.

6. The connector according to claim 1, wherein a rotation preventing mechanism for preventing rotation of said case relative to said housing of said device to be attached is formed at an engaging portion between said case and said housing of said device to be attached.

7. The connector according to claim 1, wherein a removal preventing member engaged with said hole of said housing of said device to be attached is provided for engaging said case and preventing removal of said case from said hole.

8. The connector according to claim 1, wherein a diode is disposed between said connector electric terminal members.

9. The connector according to claim 1, wherein said device to be attached is a variable displacement compressor.

10. The connector according to claim 9, wherein said variable displacement compressor is a compressor used in an air conditioning system for a vehicle.
